(19) United States
(12) Patent Application Publication
(10) Pub. No.: US 2007/0281202 A1
(43) Pub. Date: Dec. 6, 2007

(54) FUEL CELL ARRANGEMENT

(75) Inventor: Erkko Fontell, Espoo (FI)

Correspondence Address: SMITH-HILL AND BEDELL, P.C., 16100 NW CORNELL ROAD, SUITE 220, BEAVERTON, OR, 97006, US

(73) Assignee: WARTSILA FINLAND OY, Vaasa (FI)

(21) Appl. No.: 11/574,909

(22) PCT Filed: Sep. 7, 2005
(86) PCT No.: PCT/FI05/50311

§ 371 Date: Aug. 7, 2007

(30) Foreign Application Priority Data
Sep. 10, 2004 (FI) 20045335

(51) Int. Cl. H01M 8/24; H01M 8/04

(52) U.S. Cl. 429/38; 429/26

(57) ABSTRACT

A fuel cell arrangement for transporting gases to a number of fuel cell units and for exhausting reaction products from the fuel cell unit, the flow arrangement comprising a number of fuel cell units and a fastening platform onto which each fuel cell unit is supported to. The fastening platform comprises a number of separate flow channels via which the heat exchanger apparatus is in flow connection with each fuel cell unit.

The present invention relates to a fuel cell arrangement according to the preamble of claim 1 for transporting gas to a number of fuel cell units and for exhausting reaction products away from the fuel cell units, the fuel cell arrangement comprising a number of fuel cell units and a fastening platform onto which each fuel cell unit is arranged to be fitted.

Fuel cells enable the production of electric energy by releasing electrons from the hydrogen contained by the fuel gas on the anode side and by further combining the electrons to oxygen on the cathode side subsequent to having passed via an external circuit producing work. As the oxygen and electrons are combined, oxygen ions with a negative charge are formed, and ions pass from the cathode side to the anode side via electrolyte due to the potential difference. In the tri-phase interface formed by the anode, electrolyte and the fuel the hydrogen reacts with the oxygen ion, thus forming water while electrons are released into the external circuit. In order to achieve the operation each fuel cell must be supplied with oxidizing and reducing agent. Usually this is achieved by creating a flow of fuel and air on the anode and cathode side. However, the potential difference of a single fuel cell is typically so small that a fuel cell unit, a so-called stack, is formed of them, by connecting a number of cells in series. Separate units can then be further connected in series for increasing voltage. Each fuel cell unit, the so-called stack, must be provided with the substances needed for the reaction, fuel and oxygen (air), and it must also be possible to exhaust the reaction products away from the unit, i.e. gas flow systems for both the cathode and the anode side are needed. Further, it is preferable for energy economy to recover reaction heat, because especially when using solid oxide cells the temperature can be as high as about 1000° C. Taking account of such conditions in the design of a fuel cell arrangement usually leads to a relatively space-intensive solution. A clear and efficient control of the gas flows of the whole system is the problem as well as support and interconnection of the fuel cell units and the heat exchanger units to be used.

The object of the invention is to accomplish a structurally compact fuel cell arrangement.

The objects of the invention are mainly achieved as disclosed in the appended claim 1 and as more closely explained in other claims.

The basic idea of a fuel cell arrangement according to the invention is that the fuel cell units can be supported by and their gas flow arrangement can be carried out integrally by means of a fastening platform which comprises flow channels separate from each other. The fuel cell units are connected to the fastening platform by means connecting piece(s), which comprise flow paths for transporting gases to the fuel cell units and for exhausting gases away from the fuel cell units. At least two fuel cell units are connected to each connecting piece.

In one embodiment of the invention the fastening platform is formed of an elongated self-supporting piece into which longitudinal flow channels are arranged. These can be used directing the gas flows inside the actual fastening platform while the arrangement can be supported to the environment without the need for separate support beams and flow piping. The cross-section of the fastening platform is formed of at least two planar surfaces of the side part, the parts extending in the longitudinal direction of the fastening platform from the first end of the fastening platform to the second end. These planar surfaces are used for connecting the fuel cell units to the fastening platform both flow technically as well as in a supporting way. In the flow system the fuel cell units are connected to the fastening platform by means of a preferably removable separate connecting piece, the connecting piece being provided with flow channels for directing the gases to the fuel cell unit and for exhausting the reaction products away from the fuel cell unit. Preferably two fuel cell units are connected to each connecting piece. When using the system a heat transfer apparatus is used for improving the efficiency thereof and according to one embodiment of the invention the actual fastening platform forms the flow connection between the heat transfer apparatus and each fuel cell unit. The heat transfer apparatus comprises heat transfer means for flows on both the air and fuel side. Preferably the heat transfer apparatus is connected directly to the fastening platform.

In the following the invention is described by way of example and with reference to the appended schematic drawings, in which

FIG. 1 shows an embodiment of a fuel cell arrangement according to the invention in side view, and

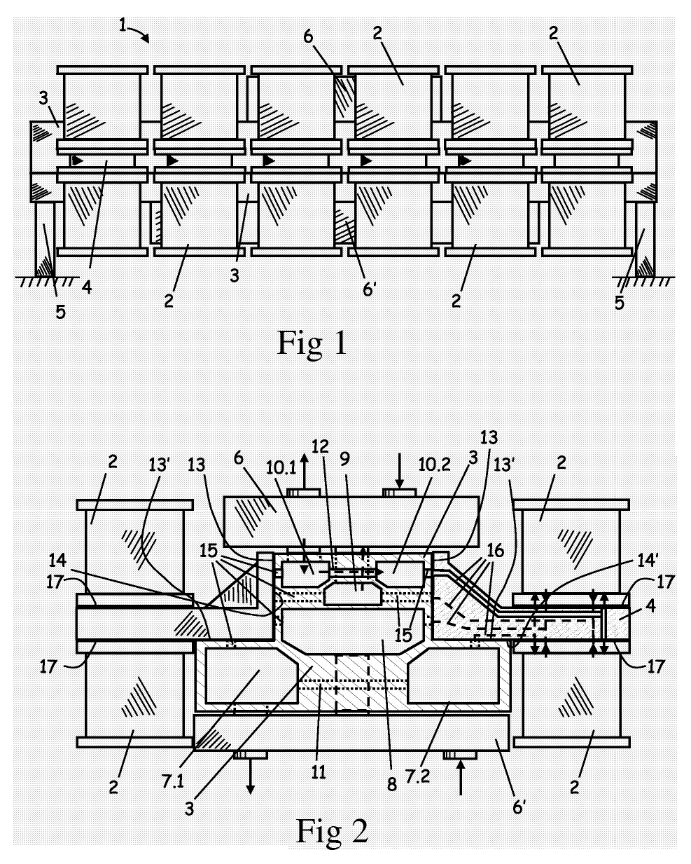

FIG. 2 shows the embodiment of FIG. 1 in a partial cross-section,

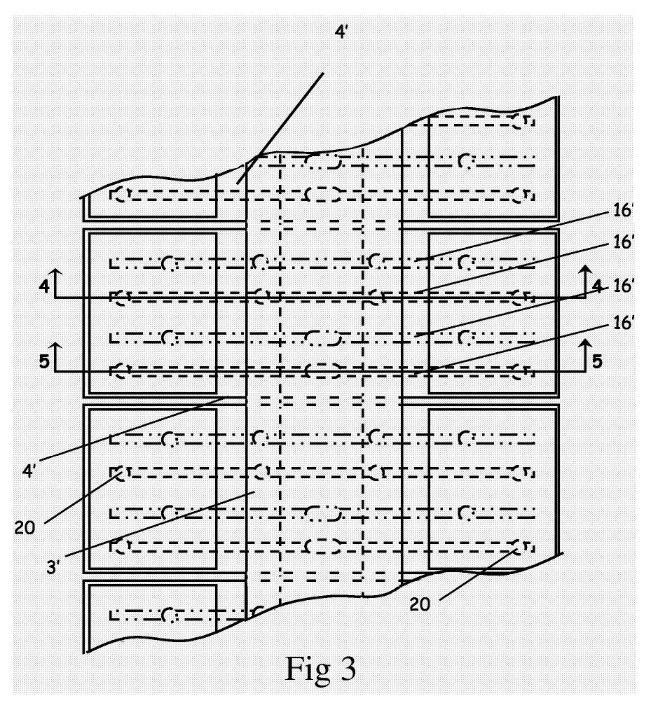

FIG. 3 shows another embodiment of a fuel cell arrangement according to the invention,

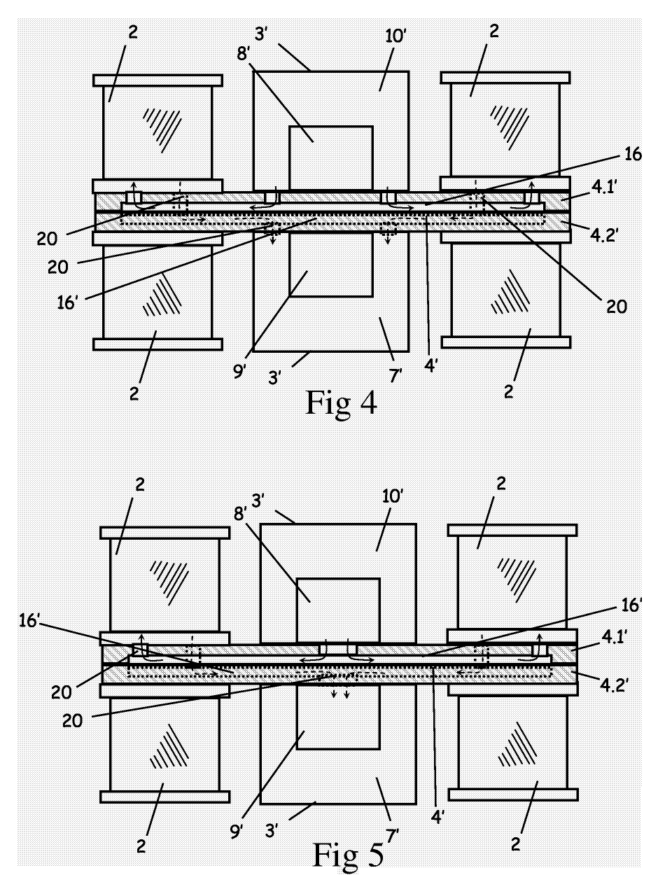

FIG. 4 is section 4-4 of FIG. 3,

FIG. 5 is section 5-5 of FIG. 3,

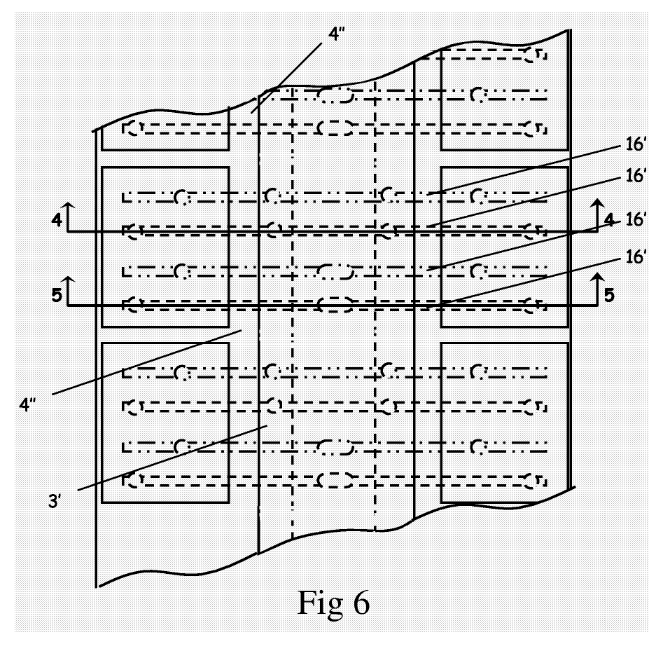

FIG. 6 shows a third fuel cell arrangement according to the invention,

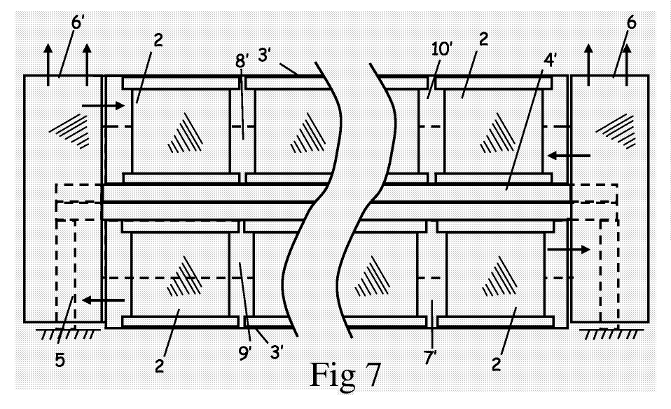

FIG. 7 shows the embodiment of FIGS. 3-5 in side view.

FIGS. 1 and 2 show a fuel cell arrangement 1, in which a number of fuel cell units 2 are supported in a longitudinal fastening platform 3. The support of the fuel cell units as well as their attachment is carried out by means of connection pieces 4 belonging to the fastening platform 3. In this embodiment the connection pieces 4 can be removed from the fastening platform 3. The fuel cell units 2 are symmetrically attached to opposite sides of the fastening platform 3, on nearly the whole length of the fastening platform 3, with an essentially even spacing. Further, the fuel cell units are arranged on the connecting pieces on the opposing sides thereof, shown in the figure on the upper and lower side. The fuel cell arrangement is supported to the environment essentially only by its fastening platform. This can be achieved, for example, by arranging fastening bars 5 at least to the ends thereof. Here, also a heat transfer apparatus 6, 6′ is attached to the fastening platform 3, which heat transfer apparatus comprises heat exchangers for the anode and cathode side flows. Here they are attached on the opposite sides of the fastening platform, on the upper and lower side in the figure. In both heat exchangers the gas to be fed into the fuel cell arrangement is heated with the gas to be exhausted from the fuel cell arrangement. Deviating from the disclosure of FIGS. 1 and 2, the heat transfer apparatuses can in some cases be arranged at the ends of the fastening platform as well.

The fastening platform 3 and the connecting pieces 4 allow the gas flow of both anode and cathode side of each fuel cell unit to be arranged in a simple way. Flow channels 7.1, 7.2, 8, 9 10.1, 10.2 for gas are arranged in the fastening platform 3, through which flow channels the heat transfer apparatus 6, 6′ is in flow connection with each fuel cell unit 2. The flow channels 7.1 and 7.2 act here as air inlet channels, through which oxygen-containing air is introduced to the fuel cell units 2 as a so-called cathode flow. In the fuel cell units the hydrogen atoms of the fuel are combined with the oxygen ions of air, forming water to the anode side gas flow, the water being water vapour in process conditions. Air is exhausted from the fuel cell unit via flow channel 8. The air to be introduced and exhausted is directed via the second heat exchanger 6′ of the heat transfer apparatus so that the exhaust air flow will warm the air flow to be introduced. Thus, the heat exchanger 6′ is in flow connection with the cathode side of the fuel cell units via flow channels 7.1, 7.2 and 8. The flow channels 7.1 and 7.2 are connected to each other by means of a flow path 11 arranged inside the fastening platform, which makes gas flow possible to the fuel cell units 2 arranged on both sides of the fastening platform in the embodiment of FIG. 2. The air to be introduced is first fed into the heat exchanger 6′, in which its temperature will rise. In the solution shown in FIG. 2, the air is subsequent to this introduced to the flow channel 7.1 and further to the flow channel 7.2 via flow channel 11.

Flow channels 10.1 and 10.2 are arranged to introduce fuel to the fuel cell units and correspondingly flow channel 9 is arranged to exhaust unused fuel away. Thus they belong to the gas flow system of the anode side. Flow channels 10.1 and 10.2 are also connected to each other via a flow channel 12.

FIG. 2 shows the arrangement of the flow channels in the cross section of fastening platform 3. Here, the arrangement of flow channels is such that the flows having higher temperature are arranged to flow into the interior parts of the fastening platform. Thus, the fastening platform itself partly acts as a heat exchanger and on the other hand heat losses to the environment are reduced. Instead of the arrangement of the flow channels as shown in FIG. 2 they can be arranged in another way as well, and two parallel flow channels are not necessarily needed for the flows as far as the operation is concerned.

The fastening platform comprises at least two side surfaces extending from the first end of the fastening platform to the second end thereof in the longitudinal direction of the fastening platform. In the embodiment of FIG. 2 the side surfaces are arranged to comprise two planar surfaces 13, 13′ being in different directions. Flow paths 15 are arranged from the flow channels 7.1, 7.2, 8, 9 10.1, 10.2, for example by drilling or already during the manufacture of the piece, to extend to both planar surfaces 13, 13′ of the side piece. Flow paths 15 open to the said planar surfaces. The planar surfaces act as fastening surfaces of the connecting pieces 4 of the fuel cell units 2. Thus the fuel cell units 2 are connected to the fastening platform 3 via removable connecting pieces 4. The connecting pieces 4 comprise mating surfaces 14, 14′ of said fastening surfaces, parallel with the planar surfaces 13, 13′, which together form the essentially gas-tight connection with the planar surfaces 13, 13′ of the fastening platform. Further, the planar surfaces 13, 13′ and the mating surfaces 14, 14′ can be fastened to each other so that the fuel cell units 2 are supported via the connecting pieces 4 to the fastening platform 3. In the disclosure of FIG. 2 the connecting pieces are mechanically connected (not shown in the figure) to preferably only one planar surface 13 located in the end of the connecting piece 13, whereby heat stresses can be minimized.

The connecting piece 4 is also provided with flow paths 16 opening onto the mating surfaces 14, 14′ so that the locations of the openings of the connecting piece correspond to the locations of the corresponding openings of flow paths 15 opening into the planar surfaces 13, 13′. The connecting piece further comprises the connecting surfaces 17 of the fuel cell unit arranged opposite each other to approximately same place of the connecting piece, in FIG. 2 above and below it, whereby two fuel cell units 2 can be connected to each connecting piece 4. The flow paths 16 of the connecting piece extend from the mating surfaces up to both connecting surface 17 of the fuel cell unit and are connectable to the flow paths 15 of the fastening platform, whereby each flow path branches inside the connecting piece for fuel cell units 2 arranged on different sides of the connecting piece.

FIGS. 3, 4, and 5 show the design principle of another embodiment of the invention. The fastening platform 3′ is arranged to act also as a gas transport channel similarly to the embodiment of FIG. 2. As can be seen from FIG. 4 and 5, the fastening platform is here a two-part one. Connecting pieces 4′, into which the fuel cell units 2 are arranged, are arranged transversely between the two-part fastening platform 3′. The connecting pieces are two-part (4.1′, 4.2′) as well and the design of both parts is such as to allow them to be arranged gas-tightly against each other. Preferably the connecting pieces are essentially plate-like structures. FIG. 3 schematically illustrates a part of the whole system. Separate flow channels 7′, 10′, 8′, 9′ are arranged in the fastening platform 3′ for the gases on the anode and cathode side and it extends from the first end of arrangement to the second end (not shown in FIG. 3). The connecting pieces 4′ are arranged in the same plane and in an angle in relation to the fastening platform. In the figure the angle is a right angle, but it can be chosen to be another angle as well. It is evident that the connecting pieces 4′ can, in a corresponding way, be formed from more than two parts.

The connecting pieces 4′ comprise at least two planar parts 4.1′, 4.2′ arranged one on the other. Flow paths 16′ are arranged to the connecting pieces as well, via which flow paths the flow channels 7′, 10′; 8′, 9′ of the fastening platform 3′ can be connected to the fuel cell units 2. The flow paths 16′ of the connecting pieces can be made by, for example, cutting a groove or grooves to one or both of the plate-like structures and by aligning the grooves suitably in the direction of the plane of the connecting piece so that they mate with the openings 20 made into the connecting pieces parallel to the normal thereof. These openings 20, parallel to the normal, are in turn in flow connection with the flow openings of the fuel cell units 2. According to the invention, the flow channels can be accomplished very flexibly and the connection method of the fuel cell units can simultaneously be carried out as desired.

FIGS. 4 and 5 schematically illustrate sections 4-4 and 5-5 of the structure of FIG. 3. FIG. 4 schematically illustrates the flow connection of air between the fastening platform 3′, connecting piece 4′ and the fuel cell units 2. Air is introduced via the flow channel 10′ of the fastening platform, wherefrom it is directed via opening 20 to the flow path 16′ of the connecting piece 4′ and from there further to the fuel cell units 2. This is shown with arrows having solid lines. The return flow of air is along a flow path 16′ arranged in the lower part 4.2″ and further to the flow channel 7′. This is shown with dotted lines. FIG. 5 schematically illustrates the flow connection of fuel between the fastening platform 3′, connecting piece 4′ and the fuel cell units 2. Fuel is introduced via the flow channel 8′ of the fastening platform, wherefrom it is directed via opening 20 to the flow path 16′ of the connecting piece 4′ and from there further to the fuel cell units 2. This is shown with arrows having solid lines. The return flow of fuel takes place along a flow path 16′ arranged in the lower part 4.2″ further to the flow channel 9′. This is shown with dotted lines.

FIG. 6 shows a solution corresponding to that of FIG. 3, in which a number of connecting pieces are connected so that the same connecting piece 4″ takes care of the gas exchange and support of number of fuel cell pairs in a row. Thus, even the gas direction of the whole fuel cell arrangement can be carried out by means of one connecting piece 4″ extending over the whole arrangement. It is also possible to integrate the actual fastening platform 3 to the connecting piece 4″.

FIG. 7 illustrates the embodiment of FIG. 3 to 5 in side view. The reference numbering corresponds to that of FIGS. 3 to 5. The figure shows the position of the heat transfer apparatus 6, 6′ in the opposing ends of the fastening platform 3′ and also the support of the arrangement to the environment by means of support bars 5 via the fastening platform 3′. In the figure, arrows show the principle of the flow connection of air and gas through the heat transfer apparatus to the flow channels 7′, 10′; 8′, 9′ of the fastening platform 3′.

The invention is not limited to the embodiments described here, but a number of modifications thereof can be conceived of within the scope of the appended claims.

1-9. (canceled)

10. A fuel cell arrangement comprising a number of fuel cell units and a fastening platform comprising separate flow channels, via which the gases flowing in the fuel cell arrangement can be introduced to and exhausted from each fuel cell unit, wherein the fuel cell units are connected to the fastening platform by means of connecting piece(s), into which flow paths are arranged for transporting gases to the fuel cell units and for exhausting gases away from the fuel cell units, and at least two fuel cell units are connected to each connecting piece.

11. A fuel cell arrangement according to claim 10, wherein the fuel cell units are connected to the opposite sides of the connecting piece.

12. A fuel cell arrangement according to claim 11, wherein the fuel cell units are connected to the upper and lower sides of the connecting piece.

13. A fuel cell arrangement according to claim 10, wherein the connecting piece(s) is/are formed of at least two plate-like parts arranged one on the other, of which at least one has grooves arranged in it for forming the flow paths.

14. A fuel cell arrangement according to claim 10, wherein the fastening platform is formed of an elongated piece, into which flow channels are arranged in the longitudinal direction thereof.

15. A fuel cell arrangement according to claim 14, wherein the flow paths of the connecting piece(s) extend transverse to the longitudinal direction of the fastening platform.

16. A fuel cell arrangement according to claim 10, wherein the fastening platform comprises at least two planar surfaces extending from the first end to the second end of the fastening platform in the longitudinal direction thereof, and that the connecting pieces are connected to the planar surfaces.

17. A fuel cell arrangement according to claim 10, wherein the arrangement comprises a heat transfer apparatus, and that the fastening platform forms a flow connection between the heat transfer apparatus and each fuel cell unit.

18. A fuel cell arrangement according to claim 17, wherein the heat transfer apparatus comprises separate heat exchangers for the anode and the cathode side flows.

19. A fuel cell arrangement comprising:
first and second fuel cell units each having at least one gas supply inlet and at least one gas exhaust outlet,
a fastening platform formed with at least one gas supply channel and at least one gas exhaust channel, and
a connecting piece formed with at least one gas supply path connecting the gas supply channel of the fastening platform to the gas supply inlets of the first and second fuel cell units and with at least one gas exhaust path connecting the gas exhaust outlets of the first and second fuel cell units to the gas exhaust channel of the fastening platform.
